(19) United States
(12) Patent Application Publication
(10) Pub. No.: US 2011/0215664 A1
(43) Pub. Date: Sep. 8, 2011

(54) Epitrochoidal Electric Motor III

(76) Inventors: Felix G. C. Wilson, II, Wichita, KS (US); Dennis L. Dreeszen, Denver, CO (US)

(21) Appl. No.: 12/719,829

(22) Filed: Mar. 8, 2010

(51) Int. Cl. H02K 7/116

(52) U.S. Cl. 310/83

(57) ABSTRACT

An electric motor contains a mechanical mechanism that causes a rotor to move in an epitrochoidal path. Disposed around the epitrochoidal path are forcers that may impel or force the rotor to rotate. The mechanical mechanism that creates the epitrochoidal path may consist of an output shaft with an eccentric lobe, where the rotor revolves around the eccentric lobe. A fixed mounted sun gear may engage a ring gear mounted to the rotor to cause the epitrochoidal motion. Some embodiments may have two or more rotors, and may include controllers with feedback sensors to operate the electric motor at a specific speed or to control the speed as defined in a speed profile.

### BACKGROUND

Many different types of rotational electric motors have been developed. The motors include motors that operate using Direct Current (DC) or Alternating Current (AC), and may include constant speed motors and variable speed motors. Linear motors have been developed that create linear force, rather than rotational torque; while frameless motors have been developed that create rotational force.

### SUMMARY

An electric motor contains a mechanical mechanism that causes a rotor to move in an epitrochoidal path. Disposed around the epitrochoidal path are forcers that may impel or force the rotor to rotate. The mechanical mechanism that creates the epitrochoidal path may consist of an output shaft with an eccentric lobe, where the rotor revolves around the eccentric lobe. A fixed mounted sun gear may engage a ring gear mounted to the rotor to cause the epitrochoidal motion. Some embodiments may have two or more rotors, and may include controllers with feedback sensors to operate the electric motor at a specific speed or to control the speed as defined in a speed profile.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing an exploded view of an electric motor with an epitrochoidal path.

FIG. 2 is a diagram illustration of an embodiment showing a plan view of an electric motor with an epitrochoidal path.

### DETAILED DESCRIPTION

An electric motor may have an internal mechanism that causes a rotor to move in an epitrochoidal path. Disposed around the epitrochoidal path may be any number of external drive embodiments that cause the rotor to rotate about the path and cause a driveshaft to turn. The internal mechanism of an illustrated embodiment may increase the speed of the rotation of the driveshaft to three times that of the rotor. Other embodiments may have different speed increases due to different configurations.

The motor may use different types of forcer assemblies to cause the motor to turn. The forcers may be constructed as a mechanism, which will engage the rotor at various points along the path of the rotor determined by the relationship between the sun gear and ring gear. Some embodiments may use, but are not limited to, a pulley sheave, frameless motor, or turbine as a forcer component combined with a fixed or moveable engagement mechanism.

The motor may use different types of forcers to cause the motor to turn. The forcers may be constructed with solenoidal-type mechanism(s) which will engage the rotor at various points along the path of the rotor determined by the relationship between the sun gear and ring gear. Some embodiments may use electromagnetic solenoids or cam driven solenoids as a forcer component.

The internal mechanism may comprise a rotor which may rotate on an eccentric component of a driveshaft. A fixed mounted sun gear may engage a ring gear mounted to the rotor, and the assembly may rotate where the driveshaft speed is faster than the rotor speed.

The rotor may have multiple lobes on which the forcer may act. In an example embodiment illustrated in this specification, a three lobed rotor is illustrated. Some embodiments may have forcer components located at the extents of the epitrochoidal path. In such embodiments, the forcer components may be segments that apply force during a segment of the rotor's path. Other embodiments may have forcer components and/or rotor components that encompass some or all of the rotor's path.

Some embodiments may have two or more rotors. In such embodiments, the rotors may be configured to be offset from each other such that each rotor moves in an epitrochoidal path that is complementary to the other rotors. In such embodiments, a rotor may be positioned so that it travels the epitrochoidal path out of phase with another rotor.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present. Additionally, connections and couplings can refer to elements in multiple planes along the x-axis and/or y-axis.

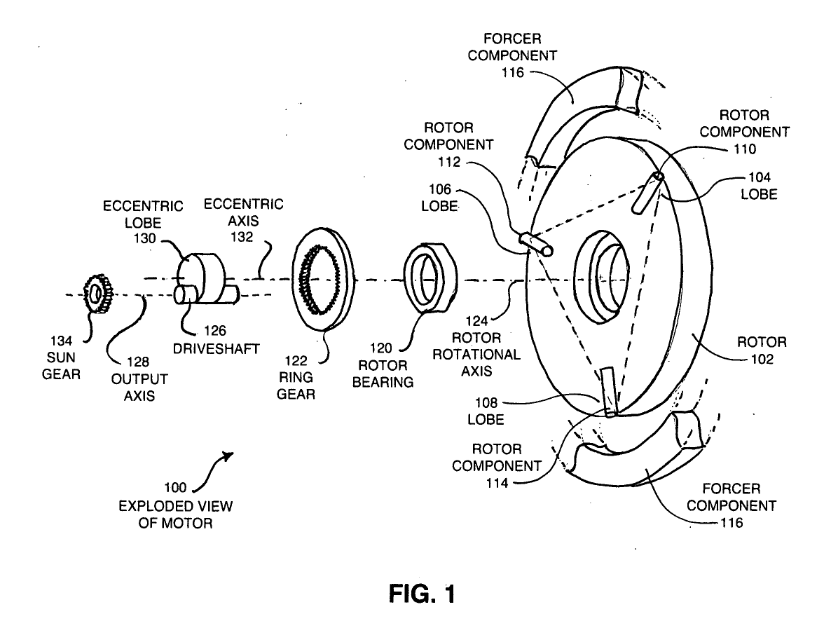

FIG. 1 is a diagram of an embodiment 100 showing an exploded view of an electrical motor with an epitrochoidal motion. Embodiment 100 is an example of one embodiment of such an electric motor.

Embodiment 100 illustrates the major components of an electric motor. The components are illustrated in an exploded view in order to show the general shape and configuration of the components. Embodiment 200 presented later in this specification illustrates a plan view showing the configuration of the components shown in embodiment 100 in their assembled positions.

An epitrochoidal motion may be created by a mechanism similar to that used in a Wankel combustion engine.

Embodiment 100 illustrates an electric motor that may be powered by one or more forcer elements. The forcer element may be powered by one or more external drive embodiments that may act together to create a force that is converted into rotational motion through a mechanism described later.

The forcer element may be any type(s) of mechanisms that may act together to create a force that is converted into to rotational motion by which energy may be converted to translational or rotational energy.

The forcer elements use translational or rotational energy to create a force that causes a rotor to rotate. In some embodiments, the forcer elements may operate on a segment of a rotor's path.

In one embodiment, one or more rotor-mounted solenoids are activated to engage the forcer. The solenoids may be mounted in a north-south position, an east-west position, or some varied angle. Additionally, the solenoids may be placed in multiple planes along the x-axis and/or y-axis.

In one embodiment, on or more forcer-mounted solenoids are activated to engage the rotor. The solenoidal-type mechanism may be mounted in a north-south position, an east-west position, or some variant angle. Additionally, the solenoids may be placed in multiple planes along the x-axis and/or y-axis.

In one embodiment, one or more rotor-mounted solenoids are activated to engage the housing. The solenoids may be mounted in a north-south position, an east-west position, or some varied angle. Additionally, the solenoids may be placed in multiple planes along the x-axis and/or y-axis.

In one embodiment, one or more housing-mounted solenoids are activated to engage the rotor. The solenoids may be mounted in a north-south position, an east-west position, or some varied angle. Additionally, the solenoids may be placed in multiple planes along the x-axis and/or y-axis.

In many forcer designs, a feedback sensor may be used to detect the motion of the rotor or output shaft and create an output signal. The output signal may be used by the controller as a feedback sensor to regulate the speed or position of the electric motor.

In some embodiments, the feedback sensor may be a Hall effect sensor. A Hall effect sensor may be a transducer that varies output voltage in responses to changes in magnetic fields. In a typical motor embodiment, a magnet may be embedded or attached to a rotor or output shaft, and the Hall effect sensor may detect each pass of the magnet past the sensor.

In some embodiments, the feedback sensor may be an encoder, such as a rotary encoder. A rotary encoder may give an output signal that defines the position of the rotor or output shaft as opposed to its speed, which could be determined using a Hall effect sensor or some other type of sensor.

When a controller is used, a controller may have an input signal that may define a desired speed or position of the motor. In some embodiments, the input signal may define a motion profile that is desired. Such a motion profile may define changes in speed or position over time. The controller may be capable of causing the output of a sensor to follow the input signal to control the motor in a closed loop feedback system.

Embodiment 100 is an example of a three-lobed rotor. The three-lobed rotor may be configured to move in an epitrochoidal path through a set of gears and by rotating about an eccentric lobe of a driveshaft. The epitrochoidal path of embodiment 100 may have two major lobes and may be in the general shape of a figure-8.

Other embodiments may have different numbers of lobes on the rotor. In general, the number of lobes of the corresponding epitrochoidal path may be one less than the number of lobes of the rotor. For example, a four-lobed rotor may be caused to move in a three-lobed epitrochoidal path in the general shape of a three-leafed clover. In another example, a five-lobed rotor may be caused to move in a four-lobed epitrochoidal path similar to a four-leafed clover.

The number of rotor components may be generally the same as, or in multiples of the number of lobes in the epitrochoidal path.

The rotor 102 has three lobes 104, 106, and 108. The lobes 104, 106, and 108 represent the apexes of the general triangular shaped rotor 102. In many three-lobed embodiments, the rotor 102 may be a Reuleaux triangle, a shape similar to, or approximating the Reuleaux triangle.

The rotor 102 has three lobes 104, 106, and 108. The lobes 104, 106, and 108 are located at 0 degrees, 120 degrees and 240 degrees around the face of rotor 102. In many three-lobed embodiments, the rotor 102 may be a circular shape, y-shaped, or triangular. Some embodiments may have more than three lobes, in such instances, the lobes may generally be placed in equilateral distances about the face of the rotor 102.

The rotor 102 may have a center hole that may define a rotor rotation axis 124. The rotor rotation axis 124 may be through the center point of the rotor 102. The rotor 102 may be defined by a plane perpendicular to the rotor rotation axis 124. The plane may be defined by rotor forcer components.

The rotor 102 may have three rotor components 110, 112 and 114 disposed about the rotor 102 at the lobes 104, 106, and 108. As illustrated, the rotor components are mounted as approximately centered over the respective lobes. Some embodiments may have rotor components offset from the respective lobes by any amount. In some cases, the rotor components may be positioned significantly ahead or behind the lobes with respect to the direction of travel.

In the illustrated embodiment, active rotor components 110, 112, and 114 are illustrated as solenoidal-type mechanism(s) are mounted to the rotor, that when activated, extends to engage the forcer component, and when deactivated, retracts to disengage the forcer component.

In some embodiments, the rotor lobes 104, 106, and 108 and components 110, 112, and 114 are passive, the forcer component 116 is illustrated with active solenoidal-type mechanism(s) mounted to the forcer, that when activated, extends to engage the rotor component, and when deactivated, retracts to disengage the rotor component.

The forcer components 116 is illustrated as a Ring-shaped compound assembly that the solenoidal-type compound rotor components may engage to facilitate rotational or translational movement.

In other embodiments, the rotor components may have two or more solenoidal-type components. In such embodiments, the rotor components may act with similar shaped stator forcer components. Such embodiments may be useful in cases where higher output torque is desired. The ring-shaped compound assembly components and rotor components as illustrated may be one configuration of a forcer mechanism. Other embodiments may have many different forcer configurations.

The forcer component 116 may be placed on the outer portions of an epitrochoidal path. An example of one embodiment may be shown in embodiment 200 presented later in this specification.

In some embodiments there may be one or more forcer mechanisms to apply rotational or translational energy to the rotor(s). The forcers may be designed to engage multiple rotors in a sequential, alternating or out of phase pattern. A number of forcers may be included to apply rotational energy to each rotor or one forcer may apply rotational force to multiple rotors.

The number of forcer components may be equal to, greater than, or less than the number of lobes on the rotor in the epitrochoidal path.

The rotor 102 may rotate about the rotor rotational axis 124 on a rotor bearing 120. A ring gear 122 may be attached to the rotor 102.

A driveshaft 126 may be the mechanism by which the output torque may be transmitted. The driveshaft 126 may have an eccentric lobe 130. The eccentric lobe 130 may be a circular portion of the driveshaft 126 that defines an eccentric axis 132. The eccentric axis 132 may be parallel to and offset from the output axis 128.

When assembled, the rotor bearing 120 may mount on the eccentric lobe 130 so that the rotor rotational axis 124 is coaxial with the eccentric axis 132.

A sun gear 134 may be mounted to a housing 136 that is not illustrated. The sun gear 134 may be sized so that the ring gear 122 may have exactly three times as many teeth as the sun gear 134. The sun gear 134 may engage the ring gear 122 and allow the rotor to rotate about the rotor rotation axis 124 while causing the driveshaft 126 to rotate about the driveshaft axis 128 at three times the speed of the rotor. For each full revolution of the rotor 102, the driveshaft 126 may rotate three complete revolutions.

The mechanism of the sun gear 134, driveshaft 126 coupled with the eccentric lobe 130 and the ring gear 122 mounted to the rotor 102 may cause the lobes 104, 106, and 108 of the rotor 102 to move in an epitrochoidal path.

In some embodiments, a controller may be used to regulate the speed and/or position of the rotor 102 and the driveshaft 126. Torque may be supplied by the actions of the forcer components acting on the rotor forcer components and causing the rotor 102 to rotate. A controller may use various feedback mechanisms, such as Hall effect sensors, encoders, or other mechanisms to sense the actions of the rotor 102. In a typical embodiment, the controller may be supplied with an input signal that indicates the desired speed or position of the rotor 102, and the controller may use the output signal of a sensor as a feedback loop to cause the rotor 102 to match the input signal.

In some embodiments, the controller may not be used and the motor of embodiment 100 may be run without feedback or in an open loop mode.

Embodiment 100 illustrates a single rotor embodiment. In some cases, two or more rotors may be used in an electric motor. When multiple rotors are used, the various rotors may be configured to be out of phase with respect to each other. Additionally, the rotor placement can refer to rotors in multiple planes along the x-axis and/or y-axis. In an example embodiment, a driveshaft may have separate eccentric lobes for each rotor. On a two-rotor system, the eccentric lobes may be positioned to be 180 degrees out of phase with each other. In a three-rotor system, the eccentric lobes may be positioned to be 120 degrees out of phase with each other. Additionally, lobe positions can refer to lobes in multiple planes along the x-axis and/or y-axis. Multiple rotor embodiments may have more power output and smoother operation than single rotor embodiments in some cases.

In a typical multiple rotor embodiment, the planes defined by each rotor may be parallel to and offset from each other.

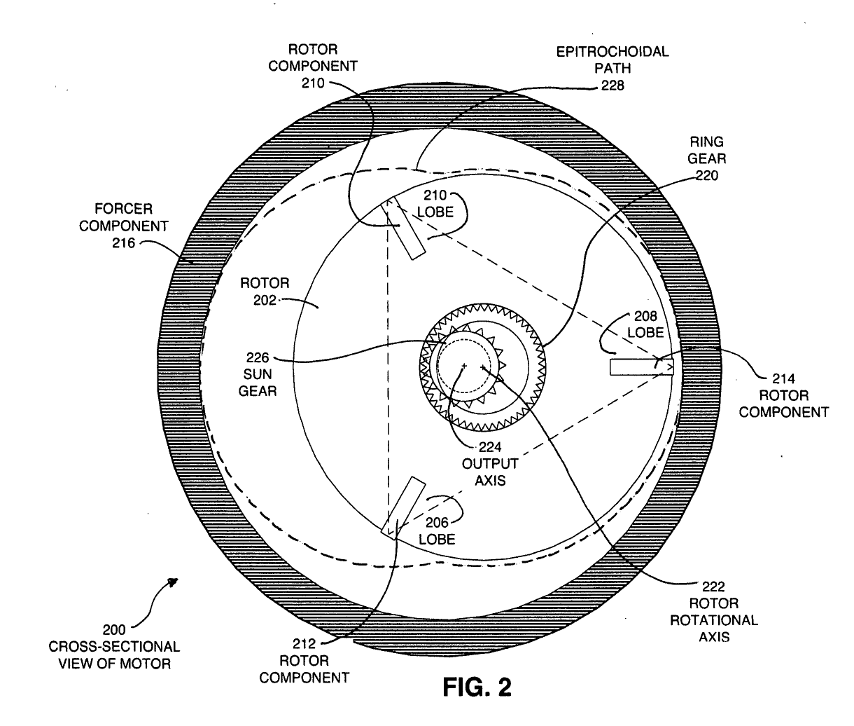

FIG. 2 is a diagram of an embodiment 200 showing a plan view of an electric motor that moves in an epitrochoidal path. Embodiment 200 is an example of a three lobed electric motor similar to embodiment 100 presented earlier in this specification. Embodiment 200 illustrates the position of the various components when the motor is assembled.

A rotor 202 is illustrated with three lobes 204, 206, and 208 and having rotor components 210, 212, and 214 located near the lobes.

The forcer component 216 is illustrated as being positioned at either end of or encompassing an epitrochoidal path 228 that may be travelled by the lobes 204, 206, and 208. The forcer component 216 is illustrated as being cut away and may be a forcer component such as forcer component 116 illustrated in embodiment 100. Additionally, forcer positioning can refer to forcers in multiple planes along the x-axis and/or y-axis.

The operation of the electric motor may proceed by the rotor component 214 interacting with the forcer component 216 to cause the rotor 202 to rotate. For example, the forcer component 216 and rotor component 214 may cause the rotor 202 to rotate clockwise. As the lobe 208 moves downward, the mechanism of the output shaft, the ring gear 220, and the sun gear 226 may cause the lobe 206 and rotor component 212 to advance to engage with the forcer component 216, where additional force may be applied to continue turning the rotor 202 clockwise. After the rotor component 212 interacts with the forcer component 216, the rotor component 210 may be in position to engage the forcer component 216 and continue the motion. Additionally, some embodiments may cause the rotor to rotate counterclockwise.

The rotor components are illustrated as being a solenoidal-type mechanism that is located in approximately a sector of a circle. Some embodiments may have multiple rotor components at each lobe. In some embodiments, the rotor components may be longer and engage a forcer component for a longer portion of a rotation.

Similarly, the forcer components 216 may be illustrated as a sector of a circle. Some embodiments may have smaller rotor forcer components. In some embodiments, the forcer components may be much larger and engage a rotor component for a longer portion of a rotation.

In some embodiments, the forcer components may extend completely around the epitrochoidal path 228. In such embodiments, the forcer components may be segmented as illustrated or may also be continuous around the rotor 202. Some embodiments may have a continuous forcer component that completely encircles the rotor 202 and may have segmented forcer components.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. An electric motor comprising:
a housing;
a rotor having a plurality of lobes and a rotor forcer component mounted at each of said plurality of lobes, said rotor having a rotational axis and a rotor plane perpendicular to said rotational axis;
a mechanism configured to cause said rotor to move in an epitrochoidal path, said epitrochoidal path being within said rotor plane; and a stator mounted to said housing, said stator comprising stator forcer components mounted along said epitrochoidal path.

2. The electric motor of claim 1, said forcer component being configured to provide rotational or translational energy to said rotor component.

3. The electric motor of claim 2, said rotor component having at least one planar face substantially parallel to said rotor plane.

4. The electric motor of claim 2, said rotor component having at least one planar face substantially perpendicular to said rotor plane.

5. The electric motor of claim 3, said forcer component comprising a ring-shape in which said rotor forcer component passes.

6. The electric motor of claim 3, said forcer component comprising a ring-shape in which said rotor forcer component passes, said forcer component comprised of solenoidal-type mechanisms

7. The electric motor of claim 1, said forcer component and said rotor component comprising rotational/translational force.

8. The electric motor of claim 1, said forcer component comprising a plurality of solenoidal-type mechanisms.

9. The electric motor of claim 1, said rotor component comprising a plurality of solenoidal-type mechanisms.

10. The electric motor of claim 1, said rotor further comprising a slip ring.

11. The electric motor of claim 1, said mechanism comprising:
a driveshaft having an output axis and an eccentric lobe, said eccentric lobe having an eccentric axis parallel to and offset from said output axis;
said rotor being mounted on said eccentric lobe such that said rotor axis is coaxial with said eccentric axis;
a sun gear mounted to said housing; and
a ring gear mounted to said rotor and engaged to said sun gear.

13. The electric motor of claim 1 further comprising: a sensor configured to determine rotational movement of said electric motor and produce an output signal; and a controller configured to receive said output signal and control said electric motor in response to an input signal.

14. The electric motor of claim 13, said sensor being mounted to detect rotational movement of said rotor.

15. The electric motor of claim 13, said sensor being mounted to detect rotational movement of said output shaft.

16. The electric motor of claim 13, said sensor being mounted to detect rotational movement of said forcer.

17. The electric motor of claim 13, said sensor being a hall effect sensor.

18. The electric motor of claim 13, said input signal defining a rotational speed.

19. The electric motor of claim 13, said input signal defining a rotational position.

20. An electric motor comprising:
a housing;
a first rotor having three lobes and a rotor component mounted at each of said three lobes, said first rotor having a first rotational axis and a first rotor plane perpendicular to said rotational axis;
a mechanism configured to cause said first rotor to move in an epitrochoidal path, said epitrochoidal path being within said first rotor plane and having two lobes, said mechanism comprising:
a driveshaft having an output axis and an eccentric lobe, said eccentric lobe having an eccentric axis parallel to and offset from said output axis;
said first rotor being mounted on said eccentric lobe such that said first rotor axis is coaxial with said eccentric axis;
a sun gear mounted to said housing; and
a ring gear mounted to said rotor and engaged to said sun gear.

21. The electric motor of claim 19 further comprising:
a second rotor having three lobes, said rotor component being mounted on each of said three lobes, said second rotor having a second rotational axis and a second rotational plane perpendicular to said second rotational axis;
said second rotor being positioned within said housing such that said second rotational axis is parallel to said first rotational axis and said first rotor plane is parallel to and offset from said second rotor plane.
